(19) United States
(12) Patent Application Publication
(10) Pub. No.: US 2015/0142672 A1
(43) Pub. Date: May 21, 2015

(54) METHOD AND APPARATUS FOR CONDUCTING OFFLINE COMMERCE TRANSACTIONS

(71) Applicant: Marvin T. LING, Scottsdale, AZ (US)

(72) Inventor: Marvin T. Ling, Scottsdale, AZ (US)

(21) Appl. No.: 14/401,998

(22) PCT Filed: May 20, 2013
(86) PCT No.: PCT/US13/41870

§ 371 Date: Nov. 18, 2014

Related U.S. Application Data
(60) Provisional application No. 61/649,469, filed on May 21, 2012.
(60) Provisional application No. 61/650,861, filed on May 23, 2012.

(51) Int. Cl. G06Q 20/40; G06Q 20/34

(52) U.S. Cl. CPC G06Q 20/4014; G06Q 20/355
USPC 705/76; 705/44

(57) ABSTRACT

Methods and apparatus for conducting offline commerce transactions that use a barcode as the user ID as an alternative means for personal identification is described. The user ID represented in the bar code format referred to as the User ID Barcode is generated from a number that uniquely identifies the user. Such numbers as a cell phone number or a credit card number or other number that uniquely identifies user may be used to generate the User ID Barcode. The unique personal identifier, the User ID Barcode is expanded to include the Country Code of the country in which the issuing company is domiciled.

### RELATED APPLICATIONS

This application is related to and claims priority to a United States provisional application entitled “SYSTEM FOR INCORPORATING THE USE OF USER ID BARCODES FOR OFFLINE COMMERCE TRANSACTIONS” filed May 21, 2012, and assigned Ser. No. 61/649,469 and a United States provisional application entitled “SYSTEM FOR INCORPORATING THE USE OF USER ID BARCODES FOR OFFLINE COMMERCE TRANSACTIONS” filed May 23, 2012, and assigned Ser. No. 61/650,861.

### FIELD OF THE INVENTION

The present invention relates to methods and apparatus for conducting offline commerce transactions using the User ID Barcode as the user identifier for purchasing goods priced at micro payment or non-micro payment level using the fund or credit limit available in the user's account in the server identified as a User Vendor Management Server (UVM).

The User ID Barcode is defined as the barcode generated from any number that uniquely identifies a user, such as credit card number, cell phone number, driver's license number or other numbers. The User ID Barcode previously defined in related applications indicated above are expanded to include Country Code, Company Code, User Index and User ID. The Country Code allows the user to make purchases of goods at any participating vendors worldwide. The company code allows any company, such as cell phone companies or large retail companies to issue the User ID Barcode in addition to banks or credit card companies. Furthermore, in order to increase the security, the User ID Barcode will have a User Index which points to the large list of encryption algorithms used to encrypt the User ID. As described in the related applications, there is a prefixed special character “?” in order to distinguish the User ID Barcode from bar codes representing products

### BACKGROUND OF THE INVENTION

Users use coins or cash for the payment of purchases of low cost goods at the present time. It is very inconvenient for users to carry coins or cash. Furthermore, it takes time for the cashier at the cash register to count changes for users. For payment of purchases in regularly priced goods, users usually are not too concerned with the time it takes to complete the purchasing transactions. However, users generally do not have patience to wait for and to complete the payment at the cash register for purchasing of goods costing at micro payment level.

Additionally, credit card companies generally prefer to ignore the purchasing transactions in micro payment made by users using cash. The transaction processing cost is too high to justify allowing users to make payment using the credit card for their purchasing transactions in micro payment amount. However, the credit card companies do allow their users to charge purchasing in micro payment amount in order to provide better services and customer satisfaction.

Many surveys indicate that the market size of cash transactions made by users is huge, many times larger than the market size of transactions made by users using credit cards.

With the prevalence of cell phones in everyday life, users now use their cell phones to purchase a variety of digital content ranging from ring tones, music, videos, games, new articles, maps, and apps. However, there was no easy and effective method to process off line micro payment transactions using a cell phone. Yet, vendors, users and cell phone service providers all realize that the market requires such a solution. Several cell phone service provider companies such as AT&T, Verizon and T-Mobile have introduced new cell phones enabling users to make contactless payment for purchases at vendor sites. These cell phones require a built in proprietary IC chip utilizing Near Filed Communication (“NFC”) technology, or have attached an NFC chip on the back of the cell phone. Recently, large retail stores such as Walmart and Target start to promote the use of cell phone with built in NFC for payments of purchases.

The use of NFC technology requires the vendor to adopt proprietary hardware in an NFC receptor to allow for the reduction of the cost of the user's purchase from the amount of pre-funded deposits by the users that is stored within the NFC. Such hardware adoption is very difficult to gain mass vendor acceptance. Any upfront capital costs to a vendor, especially small vendors, only meets with resistance creating a significant barrier to entry.

While the NFC provides users the convenience for transacting their purchases very quickly, it nonetheless does not account for security issues such as in the case of loss of the cell phone where the remaining amount of funds deposited by the user are still within the cell phone NFC. It is like a lost wallet containing cash. Furthermore, when the amount of money inside the cell phone NFC is running out, the user is required to add more money into the NFC using a special machine available only at limited places within banks or other public places. This is inconvenient for the customer.

In the meantime, other companies are realizing that a huge market opportunity exists as recently evidenced by Google including NFC functionality in their Android mobile operating system that provides a NFC payment services. Google Wallet allows consumers to store credit card and store royalty card information in a virtual wallet and then use an NFC-enabled device at terminals that also accept MasterCard PayPass transactions.

One potential problem for the cell phone company providing products with the NFC chip to their customers is that the company does not have the customer's purchasing transaction data. This means the company is not getting any profit from each and every purchase that the customer made at the vendor sites using the cell phone with NFC chip. This is contrary to a customer's use of a credit card in which the credit card company receives vendor service fees from the vendor where the customer made the purchase. Furthermore, the lack of customer's transaction data means the company supplying products with NFC chip will not have the information which is vital for market studies and strategic planning. Therefore, the major advantage that the company supplying their customers cell phones with built in NFC chip is that it may potentially attract more customers than companies supplying cell phones without the NFC chip.

DoCoMo of Japan introduced the “cell phone wallet” to the Japanese market several years ago. The DoCoMo cell phone wallet has a built in IC chip using Sony's Felica technology. Similar to cell phones with built-in NFC, the DoCoMo cell phone wallet also requires the user to add money using a special machine which is only available in a limited number of locations.

This indicates that many companies are still researching entry in providing micro payment transaction processing services.

Europay, MasterCard and Visa collectively referred as EMV, established a global standard for inter-operation of integrated circuit cards (IC cards or “chip cards”) and IC card capable point of sale (POS) terminals. It is a joint effort between Europay, MasterCard and Visa to ensure security and global interoperability so that Visa and Master Cards can continue to be accepted everywhere. The IC card does allow the user to pay for goods in micro payment, similar to cell phones with NFC chip. The potential market for the credit card with built-in IC chip or NFC chip is again for micro payment of offline purchases.

### SUMMARY OF THE INVENTION

The present invention describes the implementation of a User ID Barcode including a Country Code, the Company Code and the User Index in addition to the User ID. The inclusion of the Country Code allows any company in the world to issue the User ID Barcode. The inclusion of the Company Code allows any company in a country to issue the User ID Barcode. The User Index as introduced in the present invention identifies the specific encryption algorithm in a table of thousands of encryption algorithm maintained by the UVM that is used to encrypt the User ID. The User ID can be the credit card number, cell phone number or other number that uniquely identifies the user.

In order that the User ID Barcode can be distinguished from product barcodes being sold at vendor sites, the Country Code, the Company Code, the User Index and the encrypted User ID is prefixed with a special character such as “?” before it is converted into the barcode format to become the User ID Barcode. The User ID Barcode may be down loaded into a cell phone, making the cell phone to be a “cell phone wallet” or printed in the back of a credit card to become a “2 in 1 card” or printed in other media.

The use of thousands of algorithms permits the encryption algorithm to be different from one user to that of the others making the User ID Barcode encryption algorithm to be “user variant”. The user may request the UVM operator to issue a new User ID Barcode if the user suspects that someone copied the user's User ID Barcode or the user lost the cell phone or credit card, both of which contain the User ID Barcode. The User ID Barcode issued by the UVM differs in its encryption algorithm depending on the time of issue. Therefore the User ID Barcode encryption algorithm is “time variant”. The user variant encryption algorithm and the time variant encryption algorithm further enhance the security for the User ID Barcode.

The method and system of the present invention introduces a new transaction processing system. The system includes a Worldwide Concentrator, a Country Concentrator for each country and a UVM operated by the company. The Worldwide Concentrator contains links to Country Concentrator. The Country Concentrator contains links to several UVM servers operated by companies in that country. Each company's UVM server manages users and vendors under its control. As used herein the term “Concentrator” may be referred to as a “router”. That is, the apparatus receives encoded information and that may be in the form of data packets. The router or concentrator reads the address information in the received data to determine its ultimate destination; using this routing information, it directs the data to the next destination. The router or concentrator performs a traffic directing function to receive, partially decode and typically forward the data to a desired destination node.

When a cashier captures the User ID Barcode that a user presented for the payment of purchases, the transaction data which contains Vendor ID, products information that the user is purchasing, the total amount of user's purchases and the User ID Barcode are sent to the Vendor server. Upon receiving and detecting the “?” in the barcode, the vendor server sends the transaction data to the Worldwide Concentrator. The Worldwide Concentrator transfers the transaction data to the Country Concentrator as indicated in the first field, the Country Code, in the User ID Barcode. The Country Concentrator then transfers the transaction data to the UVM micro payment server as indicated by the Company Code in the second field within the User ID Barcode.

The present method and system uses a micro payment server called UVM. The UVM micro payment server manages Users and Vendors. The UVM processes user's off line micro payment purchasing transactions. The UVM can be operated as prepaid system or post pay system. For prepaid system, the UVM allows the user to register and create an account. The user will be required to make a certain initial amount of deposit (purchase certain amount of electronic money or “fund”) using user's credit card as determined by the company who operates the UVM. This initial amount of deposit is called “Top Off” amount. For post pay system, the user is granted a certain available credit limit called “Negative Top Off amount”. The detail of the method of adding fund to the user's UVM account using Top Off amount and restore the available credit to Negative Top Off amount are described in the related application entitled “METHOD AND APPARATUS FOR CONDUCTING OF LINE COMMERCE TRANSACTIONS” filed Aug. 16, 2011, assigned international application No. PCT/2011/047862, and published on Mar. 29, 2012 under No. WO 2012/039859.

Upon completing the required deposit registration, the company operating the UVM creates the User ID Barcode. A phone company operating the UVM may allow the registered user to down load the User ID Barcode to the user's cell phone. A credit card company operating the UVM may issue a new credit card to the registered user with the User ID Bar Code printed in the back of the credit card to become the “2 in 1 card”. Any other UVM operating company may issue the User ID Barcode and have the User ID Barcode printed in other media.

Upon receiving the transaction data, the UVM server retrieves the encryption algorithm indicated by the User Index in the third field of the User ID Barcode. The UVM decrypts the User ID within the fourth field in the User ID Barcode. The UVM server then retrieves the user account record and check to see if the user has enough money or enough available credit limit to cover the cost of the purchases. If yes, the UVM server subtracts the amount of purchase from the available fund or available credit limit in the user's account and send the “Approved” signal back to the cash register through the Country Concentrator, the Worldwide Concentrator and the vendor server. If the user's UVM account does not have enough money or enough available credit limit to cover the cost of the purchase, UVM sends a “Reject” signal back to the cash register and the user's purchasing transaction is cancelled. The processing of the user's purchasing transaction as described herein is estimated to take less than two seconds.

### BRIEF DESCRIPTION OF THE DRAWINGS

The present invention may more readily be described by reference to the accompanying drawings in which:

FIG. 1 illustrates a purchasing transaction processes using the User ID Barcode.

FIG. 2 shows the account balance after each purchasing transaction.

FIG. 3 describes the User ID Barcode.

FIG. 4 describes the beginning of the purchasing transaction processing system flow.

FIG. 5 describes the Worldwide Concentrator.

FIG. 6 describes Country Concentrator.

FIG. 7 describes the completion of the purchasing transaction processing system flow.

### DETAILED DESCRIPTION OF THE INVENTION

The User ID Barcode identifies the user and provides the user the convenient means to make the payment for off line purchases of goods the detail of which are described in the above related application. A barcode, as used herein, refers to the typical optical machine-readable representation of data. The code usually identifies data concerning the object to which it is attached and is represented by varying widths and spacing of parallel lines. The data contained in the barcode is read by conventional barcode readers or scanners that optically recognize the spacing and width of the parallel lines to derive data concerning the article to which the code is attached.

As previously described, the User ID Barcode is generated from a number that uniquely identifies the user. The user's cell phone number or the credit card number or other number that can uniquely identify the user is the unique number. This unique number is referred to as the User ID. The User ID is used to generate the User ID Barcode. The present invention introduces three new codes ahead of the User ID to further expand the use of the User ID Barcode. The first code is the Country Code in which the user made the application for the User ID Barcode. The second code is Company Code of the company that issued the User ID Barcode. The third code is the User Index which specifies the specific encryption algorithm for the User ID. The User ID with Country Code, Company Code and the User Index is pre-fixed with a special character such as “?” before the unique number is converted to the barcode format to become the User ID Barcode in order to distinguish the User ID Barcode from the barcodes representing products for sale.

The User ID Barcode is encrypted for security. The encryption algorithm for the User ID Barcode can be different for the different users. Therefore the encryption algorithm is “user variant”. The encryption algorithm can be changed with time to provide additional level of security for the user. Therefore the encryption algorithm is also “time variant”. The present invention introduces the User Index which identifies the encryption algorithm that is used to encrypt the user's unique number, the User ID. The User Index points to a very large table of encryption algorithm maintained by the UVM to accommodate user variant and time variant encryptions.

One of the key features of the present invention is that the time it takes to process the purchasing transaction made by the user using the User ID Barcode can be completed as fast as possible, within 1 or 2 seconds. The user usually has little concern with the time it takes to complete the payment for the purchase of regularly priced goods at the cash register while the vendor will have little patience to wait for the completion of payment process for purchasing goods that is in micro payment level. This results in fast checkout with the cashier and it provides the user with convenience and potentially allowing the vendor to reduce the number of cashiers and therefore reduces the vendor's operation cost.

In order to maintain fast response time for the settlement of the purchases at the cash register, the present invention allows a company to operate multiple numbers of UVMs in case there are a lot of registered users in an UVM operating company. The proper UVM in which the user information is stored can be identified by the first few digits of the user's decrypted User ID.

When the User ID Barcode is downloaded into a cell phone, the cell phone becomes the cell phone wallet, allowing the user to make the payment of purchases primarily in micro payment amount at participating vendor sites. The cashier captures the User ID Barcode as displayed in the cell phone window, using the scanner at the cash register. When the User ID Barcode generated from the credit card number is printed in the back of the credit card, it becomes the “2 in1” card. The credit card has visually identifiable information on a first side thereof indicating the name of the card holder. A magnetizable strip is positioned on a second side of the credit card having data encoded thereon including a personal identification code of the person whose name appears on the first side of the card. The User ID Barcode may be printed on the back of the credit card or printed on a label attached to the back of the credit card. The cashier swipes the credit card for user's regular purchases and captures the User ID Barcode for payment of purchase in micro payment amount. The definition of micro payment amount is flexible and it can be different among vendors.

The system and method as described in this application processes the purchasing transaction by having the vendor server transferring the transaction data, which includes the User ID Barcode, vendor ID, description of products the user purchased and the total amount of the purchase to the Worldwide Concentrator upon detecting the special character“?” as prefix to the barcode it received from the cash register. The Worldwide Concentrator extracts the Country Code in the first field of the User ID Barcode then transfers the transaction data to Country Concentrator using the link corresponding to the Country Code as listed within the Worldwide Concentrator.

The Country Concentrator then extracts the Company code within the second field of the User ID Barcode then transfers the transaction data to the UVM using the link corresponding to the Company Code as specified within the Company Concentrator.

The UVM then accesses the encryption algorithm using the User Index in the third filed of the User ID Barcode and decrypts the Encrypted User ID in the fourth and the last filed of the User ID Barcode. The system then retrieves the user's data base to see if the user has enough money or enough available credit limit in the UVM account to cover the cost of the purchase. If so, the system subtracts the amount from the user's UVM account, updates user's UVM account. In addition, the system records on the vendor data base corresponding to vendor ID, the amount to be paid to the vendor and the service fee the UVM applies to the vendor and then sends the “Approved” signal back to the cash register through the Country Concentrator, the Worldwide Concentrator and the vendor server and that completes the transaction processing. The present system and method targets the completion of the purchasing transaction processing within 1 to 2 seconds. If the user does not have the enough money in the user's UVM account, the system sends “Reject” signal back to the cash register.

FIG. 1 describes in more detail the purchasing transaction using the User ID Barcode as displayed in the cell phone window or printed in the back of a credit card as described in the related filing, “METHOD AND APPARATUS FOR CONDUCTING OF LINE COMMERCE TRANSACTIONS” filed Aug. 16, 2011, assigned international application No. PCT/2011/047862, and published on Mar. 29, 2012 under No. WO 2012/039859.

The description of the transaction represented by FIG. 1 may be found in the above-identified previously filed application and available in the designated publication document. However, it is considered useful to repeat the description here to facilitate an understanding of the present invention.

The product barcode 10 being purchased is captured using a Barcode Scanner Reader 20, step 1, and it is sent, step 2, through Cash Register 30 to the Vendor Server 40, step 3. The Vendor Server 40 sends the description of the product including the price back to the Cash Register 30, step 4 and it is displayed at the cash register Display 50, step 5 and it is printed in the Sales Slip 60, as shown in step 6. When all purchased products are entered at the cash Register 30, the user is asked to make the payment. The user shows the User ID Barcode as displayed in the cell phone or as printed in the back of the credit card to the cashier. The cashier captures the User ID Barcode 70, using the Barcode Scanner Reader 20, step 7.

The barcode scanner sends the User ID Barcode it captured to Cash Register 30, step 8, and the Cash Register 30 sends the transaction data which includes the vendor ID, the product description, the total purchasing amount, the User ID Barcode and other information to the Vendor Server 40, step 9. The Vendor Server 40 detects the special character in the barcode indicating that the barcode does not represent any products for sale and it is the User ID Barcode. The Vendor Server 40 sends the User ID Barcode together with the transaction data to the UVM server, step 10.

The UVM retrieves the User's UVM account and check to see if the user has sufficient funds in the user's UVM account. If yes, the UVM Server 80 subtracts the total cost of the user's purchases from the user's UVM account and sends the approved signal back to the Vendor Server 40, step 11, to the Cash Register 30, step 12. The Cash Register 30 displays the approval signal, step 13 and prints out the Sales Slip 60 as shown in step 14. This completes the purchasing transaction. If the user does not have sufficient funds in the user's UVM account or if there is any problem with the user's UVM account, the UVM Server 40 sends the rejection signal to the Cash Register 30 and the transaction is cancelled.

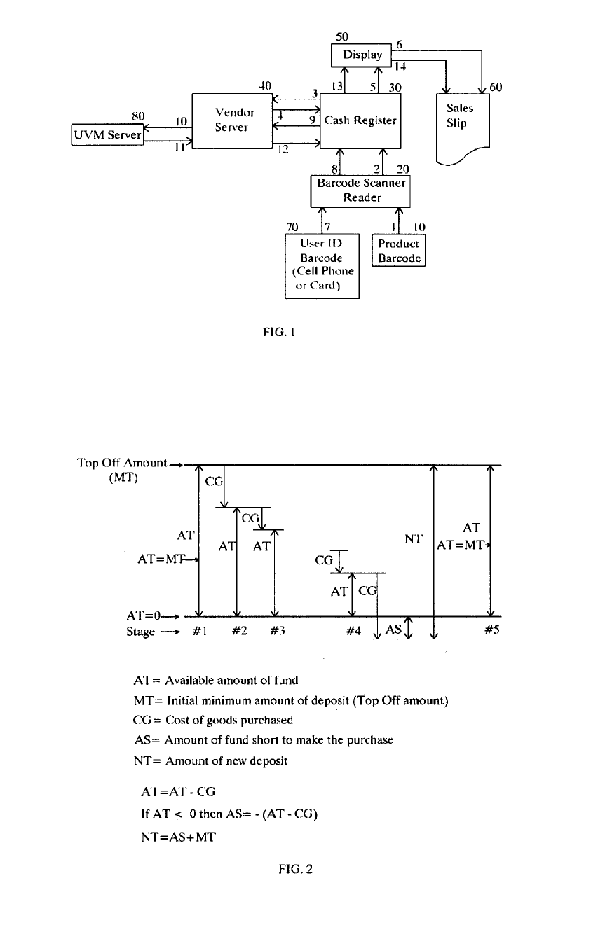

FIG. 2 shows the user account balance after each purchasing transaction for the prepaid system. In the initial stage #1, the user has the available amount of funds AT that is equal to the initial minimum amount of deposit MT (Top Off amount). In stage #2, the user makes a purchase with the cost of goods CG and the cost of goods CG is subtracted from the available amount of fund AT in the user's UVM account. Stage #3 shows that the user made more purchases and the cost of goods for the purchase is subtracted again, from the available amount of funds AT in the user's UVM account. In stage #4, the user's available amount of fund is insufficient to cover the cost of goods CG and the amount of shortage of funds to make the purchase is AS. The system automatically Adds Fund to the user's UVM account by charging the user's credit card (or the bank account whichever is the user's registered payment method) the amount NT that is AS, the amount of shortage to make the purchase plus the Top Off amount MT. The resulting balance in the user's account after this purchasing and Add Fund processes is MT, the Top Off amount, as shown in stage #5. This automatic add funds process using the Top Off concept without requiring the user to enter the amount to be added to the user's account as described above is a very important feature of the UVM because it provides a very fast means for checkout at the vendor cashier.

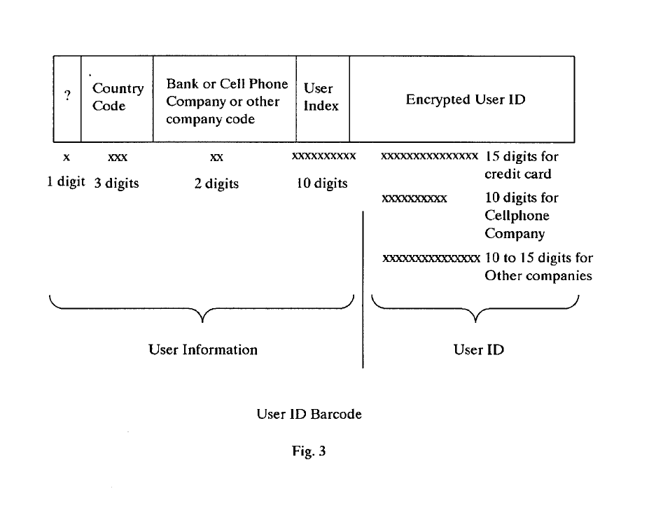

The description may now proceed by reference to the modifications and improvements that the invention imposes upon the above described method and apparatus originally disclosed in the above-identified application and available as the indicated publication document. FIG. 3 shows the User ID Barcode in detail. The User ID Barcode has “?” as the prefixed character which indicates to the vendor server that the barcode is the User ID Barcode, not the product barcode. The User ID Barcode consists of four fields. The first field is the Country Code which has 3 digits so that it can handle any country in the world. The second field is 2 digits Company Code, allowing up to 99 companies in a country to issue the User ID Barcode. This field can be expended if there are more than 99 companies in the country that will issue the User ID Barcode. The third filed is the User Index which points to one of the encryption algorithms within the table of the encryption algorithm maintained by the UVM of the company which issued the User ID Barcode to the user. The fourth filed contains the User ID encrypted with the encryption algorithm as specified by the User Index. The first, second and third filed field contains the User Information and they are not encrypted. This User Information is used to retrieve the user's UVM account.

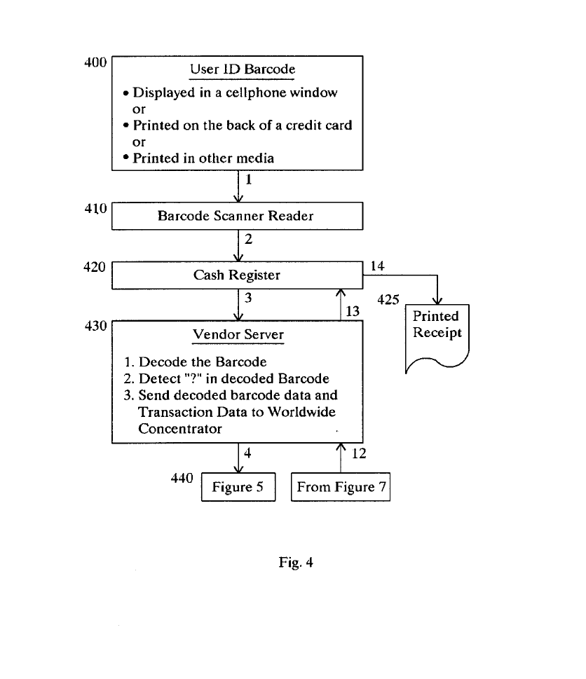

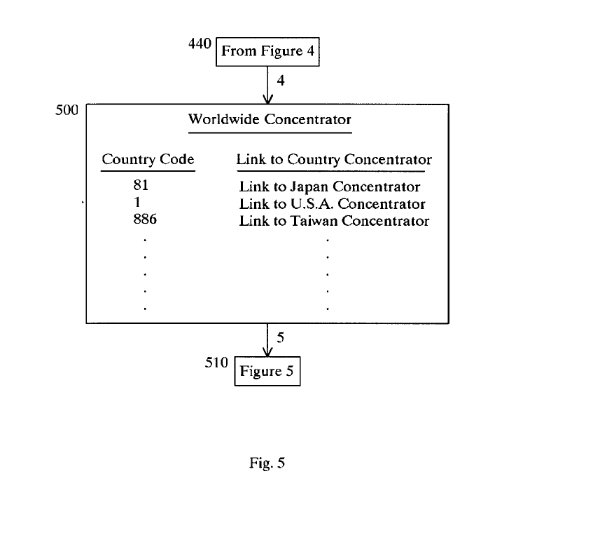

FIG. 4 describes the purchasing transaction processing at a vendor of any country. The user shows the cashier the User ID Barcode either displayed in the cell phone window or printed in the back of a credit card (2 in 1 card) or other media as shown in step 400. In step 410, the cashier captures the User ID Barcode using the scanner available at the cash register. The cash register sends, in step 420, the User ID Barcode and the transaction data to the Vendor Server. In step 430, the Vendor server decodes the barcode it received and detected that it has “?” special character as prefix in the decoded barcode. The vendor Server then sends the decoded barcode and the transaction data to the Worldwide Concentrator as shown in step 440.

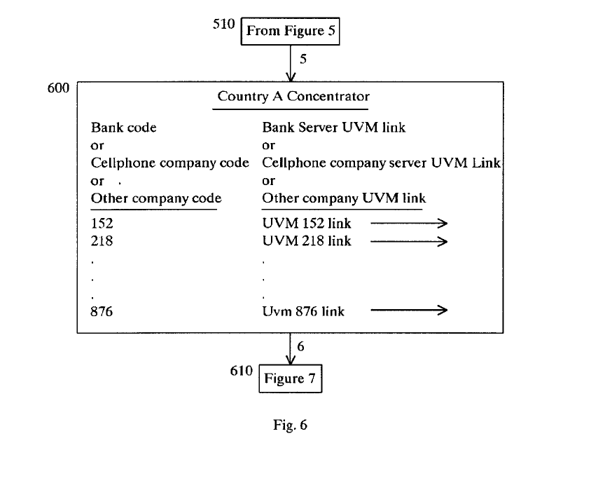

FIG. 5 is an example of a Worldwide Concentrator. It contains country codes and corresponding URL address to Country Concentrator for all countries worldwide. The process transfers to the link corresponding to the Country Code in the first field of the decoded User ID Barcode in step 510.

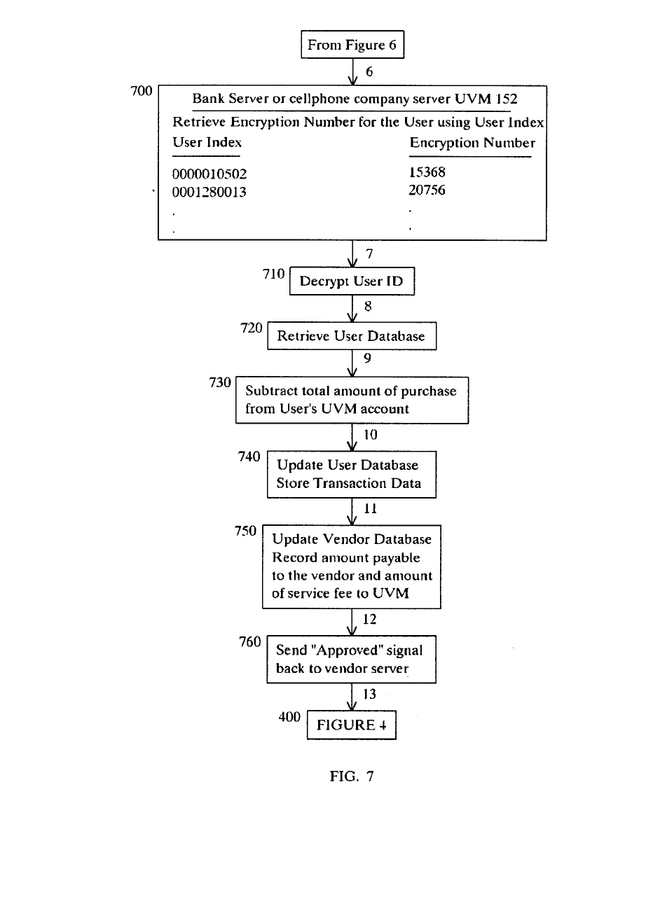

FIG. 6 is an example of Country A Concentrator. The process transfers to the link corresponding the Company Code indicated in the second field of the decrypted User ID Barcode and accessed the UVM for the company, as shown in step 610. The UVM operating company may operate multiple numbers of UVMs in case there are numerous registered users in an UVM operating company. The proper UVM in which the user information is stored can be identified by the first few digits of the user's decrypted User ID.

Referring to FIG. 7, step 700 shows the company UVM server has User Index and corresponding Encryption Number for the encryption algorithm used for the user ID. In step 710, the process extracts the User Index from the User ID Barcode and decrypts the User ID using the encryption algorithm as indicated by the User Index within the table of encryption algorithm maintained by the UVM. In step 720, the process retrieves the User Database. It then subtracts the amount of purchase from the user's UVM account in step 730. The process then updates the user's database and stores the transaction data, allowing the user to view the purchasing history at the later time as shown in step 740. In step 750, the process update the Vendor Database by recording the amount payable to the vendor due to the user's purchasing transaction and the amount of service fee that the UVM is entitled. The process then sends the “Approved” signal back to the Vendor Server as shown in step 760 and returns to the cash register in step 420 of FIG. 4 and prints the sales Receipt as shown in step 425 of FIG. 4 and that completes the purchasing transaction.

The UVM system operator, the company indicated by the Company Code, settles with each vendor upon reaching the predetermined amount or the time whichever comes first.

The purchasing transaction processing for purchases made by the user using the User ID Barcode has several advantages for the user, the vendor and the UVM operating company.

### For Users:

(1) Convenient. There is no need to carry small changes or cash.
(2) Can purchase low cost items in micro payment either on line or off line.
(3) Can earn credit card reward points even for purchasing low cost item.
(4) Can log into the UVM to view the detail of the purchasing records and the account records and manage the account.
(5) Can make purchase of low cost item, either on line or offline.
(6) High security system. The sensitive information such as the credit card number is encrypted using state-of-art encryption technology.
(7) The user can set spending threshold by each purchase amount, date, week and month.
(8) Receive confirmation email from the UVM for each and every purchasing transaction which includes the vendor name, description of the products purchased, amount, date and time.
(9) If the user discovers that the user's account has been accessed without authorization, the user can lock the account immediately using the website link that is included in the email.

### For Vendors:

(1) Fast check out. No need to enter PIN or sign the receipt making the user's purchase experience convenient increasing customer retention.
(2) May reduce the number of cashiers due to fast check out.
(3) There is little cash inside the cash registers therefore the store reduces the risk of theft.
(4) Due to convenience, there will be more customers making purchases using the User ID Barcode, increasing new registered customers, retaining a higher percentage of current customers and increasing overall vendor sales
(5) There is no cost payable to any third party for transaction processing resulting in reduced service fees to the UVM operator for vendors resulting in more participating vendors

### For UVM Operators (Company):

(1) New sources of revenue from vendor service fees for each and every user's purchases using the User ID Bar Code downloaded in the user's cell phone or printed in the back of a credit card or other media.
(2) Captures the micro payment market currently being ignored by credit card companies due to high transaction processing cost.
(3) The market for the low cost items is substantially larger than the market for the conventionally priced items over $5.00 purchased using the credit card, representing a significant new business opportunity for the UVM operating company.
(4) Added convenience, ease of use, security and less transaction costs will contribute to increased popularity of using the User ID Barcode to make purchases.
(5) Attract more new users to register for the User ID Barcode resulting in more market share.
(6) No service fee payable to a third company for processing the purchasing transaction, currently used by credit card companies to authenticate the credit card transactions as the UVM operates the system and charges the entire service fee directly to the vendor themselves, eliminating the third party payment processor.
(7) No need to send invoices to users, further reducing the operating and transaction cost.
   Can attract more new vendors to become the UVM participating vendors due to many benefits for vendors

What is claimed:

1. A method for conducting offline commerce transactions comprising:
(a) providing a personal code to a person, identified as the User ID for their use to purchase goods;
(b) converting said personal code into barcode format to form a User ID Barcode;
(c) said User ID Barcode corresponding to said personal code and including at least one special character to distinguish the barcode as a User ID Barcode;
(d) said User ID Barcode including a plurality of fields including one selected field from a country code field, a company code field, a user index field, and an encrypted User ID; and
(e) scanning said User ID Barcode to derive said personal code to obtain authorization for a purchase.

2. The method of claim 1 wherein said one selected field is a country code field.

3. The method of claim 1 wherein said one selected field is a company code field.

4. The method of claim 1 wherein said one selected field is a user index field indicating which specific encryption algorithm is used to encrypt the User ID.

5. The method of claim 1 wherein said one selected field is the User ID.

6. The method of claim 1 wherein said plurality of fields includes a country code field, a company code field, a user index code indicating which specific encryption algorithm is used to encrypt the User ID, and an encrypted User ID code.

7. The method of claim 1 including downloading said User ID Barcode into a cell phone having a window:
(a) displaying said User ID Barcode on the cell phone window; and
(b) scanning said User ID Barcode displayed in said window to derive said personal code to obtain authorization for a purchase.

8. The method of claim 1 including printing said User ID Barcode in the back of a credit card; scanning said User ID Barcode in the back of a credit card to obtain authorization for a purchase.

9. The method of claim 1 including printing said User ID Barcode in any other media; scanning said User ID Barcode to obtain authorization for a purchase.

10. The method of claim 1 wherein said User ID is a credit card number assigned to said person.

11. The method of claim 1 wherein said User ID is any number that uniquely identify said person.

12. An improved credit card structure comprising:
(a) a credit card having a visually identifiable information on a first side thereof indicating the name of the card holder;
(b) a magnetizable strip on a second side thereof having data encoded thereon including a personal identification code of the person whose name appears on the first side of said card; and
(c) a barcode secured to one of said sides, said barcode including a plurality of fields including one selected from a country code field, a company cold field, a user index field, and an encrypted User ID.

13. The improved credit card structure of claim 12 wherein said User ID Barcode is printed on one of said surfaces.

14. The improved credit card structure of claim 12 wherein said barcode is printed on a label or sticker secured to one of said surfaces.

15. A cell phone having a window and means for entering data for appearance in said window, the improvement comprising:
(a) a User ID Barcode stored in said cell phone and viewable in said window to enable a barcode scanner to scan said User ID Barcode in said window; and
(b) said User ID Barcode including a plurality of fields including one selected field from a country code field, a company code field, a user index field, and an encrypted User ID.

16. A transaction processing system having a vendor server for receiving data including identification of a product being purchased, the purchase price of the product, and a purchaser's User ID Barcode comprising:
(a) a worldwide concentrator connected to said vendor server for receiving said data from the vendor server and forwarding said data to a country concentrator specified in said User ID Barcode;
(b) said country concentrator connected to said worldwide concentrator for receiving said data and forwarding said data to a company concentrator specified in said User ID Barcode;
(c) said company concentrator connected to said country concentrator for receiving said data and forwarding said data to a user vendor management server (UVM) specified in said User ID Barcode; and
(d) said UVM connected to said company concentrator for receiving said data and for providing an approval or rejected signal to said vendor server.

17. The transaction processing system of claim 16 wherein said UVM includes an encryption table to provide a selected encryption algorithm for decrypting a User ID identified in said User ID Barcode.

18. The transaction processing system of claim 17 wherein said UVM chooses said selected encryption algorithm in response to a user index field in said User ID Barcode.
